(19) United States
(12) Patent Application Publication
(10) Pub. No.: US 2007/0047380 A1
(43) Pub. Date: Mar. 1, 2007

(54) Extruder screw tip

(76) Inventors: Craig A. Benjamin, Lebanon, OR (US); Bainian Oian, Corvallis, OR (US)

Correspondence Address: Robert E. Howard, P.O. Box 10345, Eugene, OR, 97440-2345, US

(21) Appl. No.: 11/358,291

(22) Filed: Feb. 20, 2006

Related U.S. Application Data
(60) Provisional application No. 60/712,992, filed on Aug. 30, 2005.

(51) Int. Cl. B29B 7/58; B29C 47/64

(52) U.S. Cl. 366/81

(57) ABSTRACT

A tip adapted to be mounted to the downstream end of an extruder screw. The tip includes a nose section and an extruder screw mount section. The nose section includes an upstream face and a first and second downstream faces. The upstream face has a major plane that is substantially perpendicular to the longitudinal axis of the tip, is substantially flat, and has a substantially circular perimeter. The first and second downstream faces have major planes that are substantially flat. The major plane of the first downstream face is at an angle to the major plane of the second downstream face whereby they meet at a juncture located at the outer end of the tip. The extruder screw mount section includes means for attaching the tip to the extruder screw.

### CROSS-REFERENCE TO RELATED APPLICATIONS

This application claims the benefit of U.S. Provisional Application No. 60/712,992, filed Aug. 30, 2005.

### BACKGROUND OF INVENTION

The present invention relates to a screw tip for extruder screws. The extruder screw tip can be used with screws used with single screw extruders or with screws used with twin screw extruders.

Extruders are machines used to process polymeric material from a solid particulate form into a flowable form (“melt”) that can then be passed through a die to form continuous sheets or other shapes, or injected into a mold to form shaped objects. Extruders typically have an elongated, heatable barrel into which a rotatable screw or screws are inserted and mounted. The screw or screws are driven by motor means. The particulate polymeric material is introduced into the upstream end of the barrel through one or more feed ports and is conveyed along the barrel by the helical flights of the rotating screw or screws. During traverse of the barrel from the feed port to the discharge end, the polymeric material is heated and converted into a molten mass or otherwise flowable form. Near the discharge end of the extruder, the melt flows over and around a screw tip located on the discharge end of the screw. Such screw tips are conventionally spherical, cylindrical or conical in shape. It has been found that such shapes create an amount of friction that can impart undesirable heat transfer to the melt in some applications.

### SUMMARY OF THE INVENTION

It is an object of the present invention to provide an extruder screw tip which reduces the amount of heat generation and heat transfer from the screw tip to the melt.

The tip of the present invention is adapted to be mounted to the downstream end of an extruder screw. The tip includes a nose section and an extruder screw mount section. The nose section includes an upstream face and a first and second downstream faces. The upstream face has a major plane that is substantially perpendicular to the longitudinal axis of the tip, is substantially flat, and has a substantially circular perimeter.

The first and second downstream faces have major planes that are substantially flat. The major plane of the first downstream face is at an angle to the major plane of the second downstream face whereby they meet at a juncture located at the outer end of the tip. The major plane of the second downstream face is substantially parallel to the longitudinal axis of the tip. The extruder screw mount section includes means for attaching the tip to the extruder screw.

### BRIEF DESCRIPTION OF THE DRAWINGS

FIG. 1 is a right front perspective view of the extruder tip of the present invention;

FIG. 2 is a right side elevational view of the extruder tip;

FIG. 3 is a front elevational view of the extruder tip; and

FIG. 4 is a rear elevational view of the extruder tip.

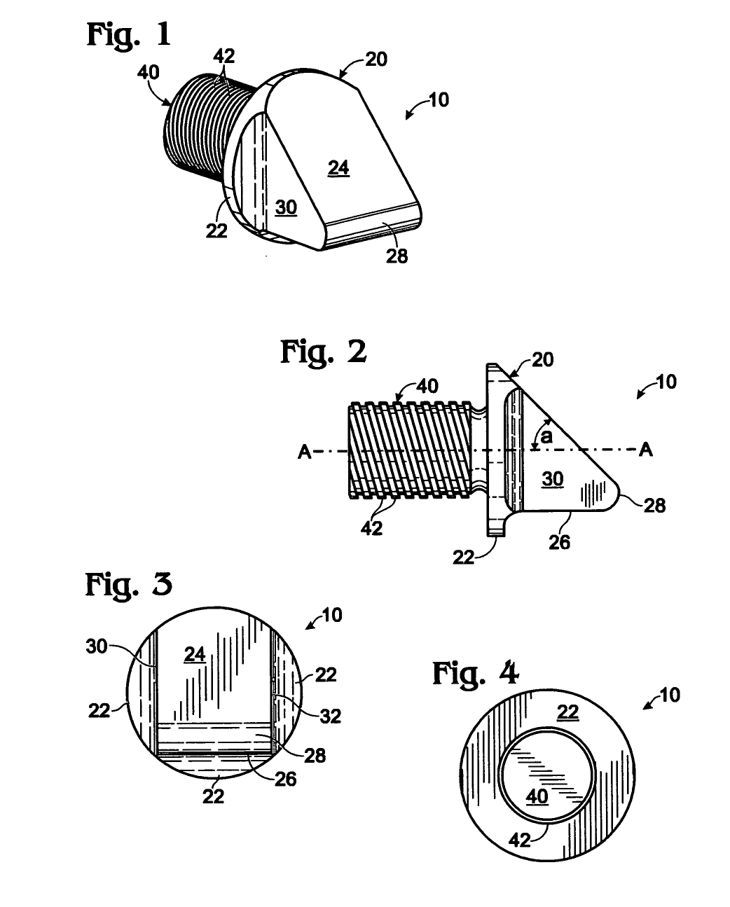

### DESCRIPTION OF PREFERRED EMBODIMENTS

The extruder screw tip 10 of the invention includes a nose section 20 and an extruder screw mount section 40.

Nose 20 has a upstream face 22 whose major plane is substantially perpendicular to the longitudinal axis A-A of screw tip 10 and the extruder screw upon which it is mounted. Upstream face 22 is substantially flat and has a substantially circular perimeter having a center lying along longitudinal axis A-A.

Nose 20 has a first downstream face 24 and a second downstream face 26. First and second downstream faces 24 and 26 have major planes that are substantially flat. The major plane of first downstream face 24 is at an angle “a” to longitudinal axis A-A. Preferably angle “a” is about 45 degrees. The major plane of second downstream face 26 is substantially parallel to longitudinal axis A-A.

First and second downstream faces 24 and 26 meet at a juncture 28 that is rounded.

A substantially flat right side wall 30 extends between the right edges of first and second downstream faces 24 and 26. A substantially flat left side wall 32 extends between the left edges of first and second downstream faces 24 and 26. Right and left side walls 30 and 32 are substantially perpendicular to the major plane of second downstream face 26.

The juncture of first and second downstream faces 24 and 26 with upstream face 22, and the juncture of right a left side walls 30 and 32 with upstream face 22, are rounded.

Extruder screw mount 40 is cylindrical in shape, and has external threads 42 adapted to mate with internal threads located within the downstream end of an extruder screw.

Extruder screw tip 10 can be formed as a single piece or multiple pieces that are fastened together.

It will be obvious to those having skill in the art that many changes may be made to the details of the above-described embodiments of this invention without departing from the underlying principles thereof. The scope of the present invention should, therefore, be determined only by the following claims.

The invention claimed is:

1. A tip adapted to be mounted to the downstream end of an extruder screw in a manner such that the longitudinal axis of said extruder screw and the longitudinal axis of said tip are coextensive, said tip comprising:
a nose section and an extruder screw mount section;
said nose section including an upstream face and a first and second downstream faces;
said upstream face having a major plane that is substantially perpendicular to the longitudinal axis of said tip, said upstream face being substantially flat and having a substantially circular perimeter having a center lying along said longitudinal axis of said tip;
said first and second downstream faces having major planes that are substantially flat, the major plane of said first downstream face being at an angle to the major plane of said second downstream face and to the longitudinal axis of said tip so that they meet at a juncture located at the outer end of said tip;
said extruder screw mount having means for attachment to the downstream end of an extruder screw.

2. The tip of claim 1 wherein said angle between said first and second downstream faces is about 45 degrees.

3. The tip of claim 1 wherein the major plane of said second downstream face is substantially parallel to said longitudinal axis of said tip

4. The tip of claim 1 wherein said first and second downstream faces meet at a juncture that is rounded.

5. The tip of claim 1 wherein said upstream face and said first and second downstream faces meet at a juncture that is rounded.

6. The tip of claim 1 wherein said extruder screw mount is cylindrical in shape and has a longitudinal axis that is coextensive with the longitudinal axis of said tip.

7. The tip of claim 6 wherein said means for attachment of said extruder screw mount to the downstream end of an extruder screw includes external threads adapted to mate with internal threads located within the downstream end of said extruder screw.
